(19) United States
(12) Patent Application Publication
(10) Pub. No.: US 2021/0165758 A1
(43) Pub. Date: Jun. 3, 2021

(54) MULTI-CORE SYSTEM OF ELECTRIC VEHICLE AND OPERATING METHOD THEREOF

(71) Applicant: CAMMSYS Corp., Incheon (KR)

(72) Inventors: Min Soo SONG, Hwaseong-si (KR); Myung Sang KWON, Jincheon-gun (KR)

(21) Appl. No.: 16/719,156

(22) Filed: Dec. 18, 2019

(30) Foreign Application Priority Data
Dec. 3, 2019 (KR) 10-2019-0158719

(51) Int. Cl. G06F 15/173; B60L 50/60; B60W 10/30; B60W 50/06

(52) U.S. Cl. CPC G06F 15/17331; B60L 50/60; B60W 2050/0005; B60W 50/06; B60W 10/30

(57) ABSTRACT

A multi-core system of an electric vehicle according to an aspect of the present invention is a multi-core system for performing a plurality of applications used in an electric vehicle including a processor unit configured to perform the plurality of applications, a plurality of core units which is formed in the processor unit and assigned with at least one of the plurality of applications, and a resource unit which is commonly used in the plurality of core units and executes the plurality of applications, wherein the resource unit is formed with at least one of a GPIO, an interrupt, a timer, an analog-digital conversion module (ADC), a communication module (CAN), and a memory, and the memory is formed so that the plurality of core units transmits information to each other.

### CROSS-REFERENCE TO RELATED APPLICATION

This application claims under 35 U.S.C. § 119(a) the benefit of Korean Patent Application No. 10-2019-0158719 filed on Dec. 3, 2019, the entire contents of which are incorporated herein by reference.

### BACKGROUND

### (a) Technical Field

The present invention relates to a multi-core system of an electric vehicle and an operating method thereof, and more particularly, to a multi-core system of an electric vehicle and an operating method thereof, in which a plurality of multi-cores is configured in a microprocessor, the plurality of multi-cores commonly uses resources, and applications are independently operated and performed.

### (b) Background Art

An electric vehicle (EV) means a vehicle using an electric battery and an electric motor without using petroleum fuels and an engine. As the EV, a pure electric vehicle (EV) which travels only with a battery and an electric motor, a hybrid electric vehicle (HEV), and a plug-in hybrid electric vehicle (PHEV) have been developed.

In addition, considering a case where a pure electric vehicle system and an internal combustion engine vehicle are modified to an electric vehicle, a space and a weight have an effect on the entire specification of the vehicle, and thus methods for how to take the space and the weight have been studied and invented.

Considering this, how to configure the system and which main electronic part is selected become an important factor of affecting a total traveling distance for once charging of the vehicle, a climbing capacity, and a maximum speed as an example. Accordingly, even in the related art, main ECU functions of the electric vehicle are integrated into one to reduce the space and the weight.

In a method of integrating the main ECUs into one, generally, a method of implementing functions of the main ECUs (OBC, LDC, VCU, MCU, HVAC, etc.) in a microprocessor having one core or a method of separately applying each function to a plurality of microprocessors configured by one core is selected.

These methods are to generally apply an application for performing a specific function (traveling, rapid/slow charging, air conditioning, etc.) to various microprocessors from various manufacturers.

The application for performing the specific function has a microprocessor-dependent part, and thus as necessary, if a specific application needs to be applied to another microprocessor from another manufacturer, to this end, in some cases, a lot of human resources and time may also be required.

### SUMMARY

The present invention is derived to solve the problems above and an object of the present invention is to provide a multi-core system of an electric vehicle and an operating method thereof capable of assigning a plurality of applications to a plurality of cores.

Another object of the present invention is to provide a multi-core system of an electric vehicle and an operating method thereof capable of using commonly resources of a microprocessor by a plurality of cores and performing independently operations.

To achieve the above objects, a multi-core system of an electric vehicle according to an aspect of the present invention is a multi-core system for performing a plurality of applications used in an electric vehicle including a processor unit configured to perform the plurality of applications, a plurality of core units which is formed in the processor unit and assigned with at least one of the plurality of applications, and a resource unit which is commonly used in the plurality of core units and executes the plurality of applications, wherein the resource unit is formed with at least one of a GPIO, an interrupt, a timer, an analog-digital conversion module (ADC), a communication module (CAN), and a memory, and the memory is formed so that the plurality of core units transmits information to each other.

The application may be formed of a plurality of software components (SWCs), and the plurality of SWCs may move from the plurality of core units, respectively.

The plurality of core units may be formed, and when an error occurs, the application may move to the other core unit to perform functions of the application.

The processor unit may receive a change in alive count value set in the plurality of core units to determine the errors of the core units.

The processor unit may be embedded in integrated hardware together with a power distribution unit (PDU) distributing a high-voltage power supply line.

The processor unit may share information via LIN and CAN communications with at least one electronic unit of a battery management system (BMS) and an on-board charger (OBC) which are formed outside the integrated hardware.

The core units may be divided into a high-performance core assigned with the high-performance application and a low-performance core assigned with the low-performance application.

The low-performance core may be assigned with the low-power application by considering energy efficiency.

To achieve the above objects, an operating method of a multi-core system of an electric vehicle according to an aspect of the present invention is an operating method of a multi-core system for performing a plurality of applications used in an electric vehicle including (a) disposing a plurality of core units and a resource unit in a processor unit, (b) dividing the plurality of core units into a high-performance core and a low-performance core, (c) assigning the application to each of the plurality of core units, (d) executing the application in the resource unit, (e) detecting an error by monitoring the plurality of core units, and (f) moving the application of the core unit having the error to the other core unit.

In step (e), the processor unit may receive a change in alive count value set in the plurality of core units and monitor the received change in alive count value to determine the errors of the core units.

According to the multi-core system of the electric vehicle and the operating method thereof of the present invention, it is possible to maximally use the resources of the microprocessor by assigning and using the plurality of applications to the plurality of cores.

Further, a user may determine in advance to perform a specific function in a specific core and perform the determined function for an independent time to be optimized in terms of applications and resource utilization depending on a vehicle system operation strategy.

Further, since microprocessor-dependent parts as lower ends of the applications are common, a specific application may be easily moved from a core to another core.

Further, hardware is integrated into one to significantly reduce a weight of a case which has been implemented for each electronic unit for waterproof, falling, heat shock, and cooling.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a block diagram schematically illustrating a multi-core system of an electric vehicle according to an embodiment of the present invention;

FIG. 2 is a block diagram schematically illustrating a processor unit according to an embodiment of the present invention; and

FIG. 3 is a flowchart illustrating an operating method of a multi-core system of an electric vehicle according to an embodiment of the present invention.

### DETAILED DESCRIPTION

Hereinafter, embodiments of the present invention will be described in detail with reference to the accompanying drawings. However, the present invention is not limited to these embodiments and may be modified in various forms.

In the drawings, in order to clearly and simply describe the present invention, parts irrelevant to the description are not illustrated, and throughout this specification, like or very similar parts use like reference numerals. In addition, in the drawings, in order to much more clarify the description, thicknesses, widths, etc. are enlarged or reduced, and the thicknesses, the widths, etc. of the present invention are not limited to those illustrated in the drawings.

In addition, throughout this specification, when any part “includes” another part, another part is not excluded, but another part may be further included unless otherwise stated.

Hereinafter, a multi-core system of an electric vehicle and an operating method thereof will be described in detail with reference to the accompanying drawings.

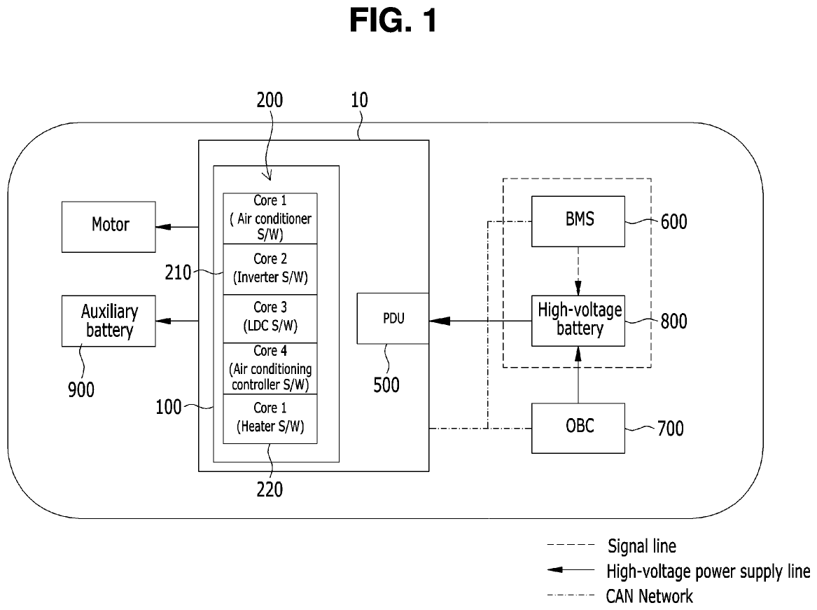

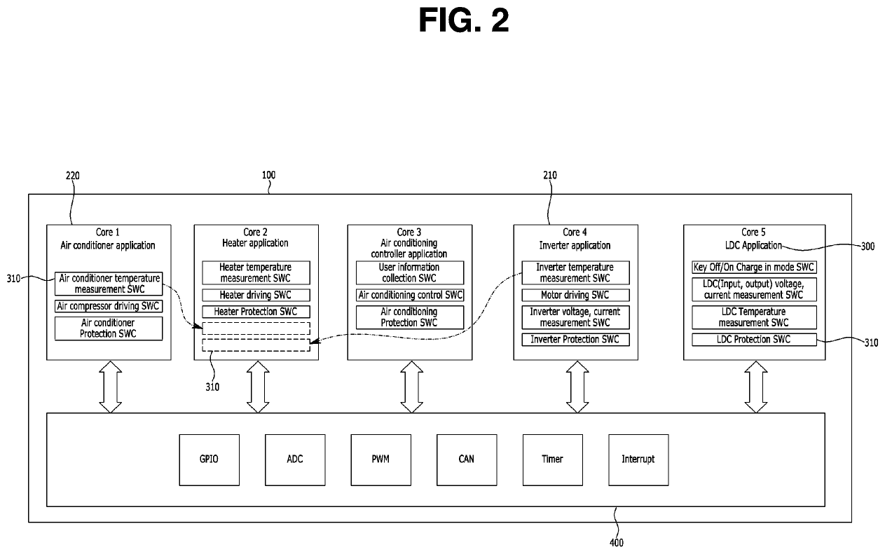

FIG. 1 is a block diagram schematically illustrating a multi-core system of an electric vehicle according to an embodiment of the present invention and FIG. 2 is a block diagram schematically illustrating a processor unit according to an embodiment of the present invention.

As illustrated in FIGS. 1 and 2, a multi-core system of an electric vehicle according to an embodiment of the present invention includes a processor unit 100 which performs a plurality of applications 300, a plurality of core units 200 which is formed in the processor unit 100 and assigned with at least one of the plurality of applications 300, and a resource unit 400 which is commonly used in the plurality of core units 200 and executes the plurality of applications 300. Components included in the multi-core system of the electric vehicle are not necessarily limited thereto.

The electric vehicle means all vehicles which include a battery 800 and an electric motor driving wheels by using electricity charged in the battery 800. The electric vehicle includes a plug-in hybrid electric vehicle (PHEV) as well as an electric vehicle (EV). The electric vehicle charges in the battery 800 electricity received from an on-board charger (OBC) 700 as electric vehicle supply equipment installed in buildings.

In addition, the electric vehicle is connected to the charger 700 when one side of a predetermined charge cable is connected to an inlet of the electric vehicle and the other side of the charge cable is connected to the charger 700 so as to receive the electricity from the charger 700.

Further, the electric vehicle performs data communication with an integrated control center via a network by using a communication module provided. The electric vehicle includes a memory for storing programs or protocols for communicating with the integrated control center via the network, a microprocessor for operating and controlling by executing the corresponding program, etc.

The multi-core system of the electric vehicle of the present invention is to execute the plurality of applications 300 by forming the plurality of cores in the microprocessor.

The processor unit 100 is embedded and formed in integrated hardware 10 together with a power distribution unit (PDU) 500 distributing a high-voltage power supply line, and the plurality of core units 200 is formed in the processor unit 100. As such, the integrated hardware 10 embedded with the processor unit 100 and the PDU 500 is embedded with the plurality of core units 200 to reduce significantly a weight of a case which has been implemented for each electronic unit 900 for waterproof, falling, heat shock, and cooling. In addition, the processor unit 100 embedded in the integrated hardware 10 is connected with various electronic units 900 such as a battery management system (BMS) 600 formed outside the integrated hardware 10, the OBC 700, etc. via LIN and CAN transceivers.

At this time, the high-voltage line which is formed outside the integrated hardware 10 connects the high-voltage battery 800 and the PDU 500 to each other. In addition, the high-voltage battery 800 distributes the power to a place where a high voltage is required, such as a motor, an auxiliary battery 800, and a conditioner, which are formed outside the integrated hardware 10, as needed.

The plurality of core units 200 is formed to assign the plurality of applications 300 for operating the electric vehicle, respectively, to be configured to the processor unit 100. At this time, the applications 300 assigned to the core units 200 are formed with a plurality of software components (SWCs) 310 and the plurality of SWCs 310 may move from the plurality of core units 200, respectively. The plurality of core units 200 commonly uses the resources of the resource unit 400 formed in the processor unit 100 and each application 300 assigned to each core unit 200 independently performs the operation. At this time, the plurality of core units 200 assigns the applications 300, such as an air conditioner, a heater, an air conditioning control, an inverter, and an LDC.

Specifically, the core unit 200 assigned with the inverter application 300 among the plurality of core units 200 has a function of controlling the motor and is configured with a software component 310 which is assigned with the application 300 to be performed by the inverter and drives the motor by performing calculation of a target torque value according to regenerative braking and acceleration pedaling. In addition, the inverter application 300 is formed as the software component 310, such as measurement of an inverter temperature, measurement of inverter IN/OUT voltage and current, and inverter protection. In such a form, the functions of other electronic units 900 are performed at a specific core unit 200 to be assigned with a user's intention, and when the function is assigned to the core with the user's intention, generally, one core should not perform too many functions.

Further, in order to measure the temperature in the core unit 200 assigned with the inverter application 300, an ADC module of the processor unit 100 is used, and since the number of ADCs is limitative, the ADC to be used for each application 300 is determined in advance. As such, PWM, GPIO, Timer, and Interrupt determine resources to be used by the user's intention for each application 300 in advance.

In addition, the software components 310 for performing the plurality of applications 300 may move to each other in the plurality of core units 200 formed in the processor unit 100. As the plurality of core units 200 commonly uses the resource unit 400 of the processor unit 100, dependent parts are formed in common with each other so that the software components 310 of different core units 200 may move to each other. Accordingly, when an error occurs in one core unit 200 among the plurality of core units 200 due to the damage of the processor unit 100 and the damage of the core unit 200, the software component 310 of the core unit 200 having the error moves to perform the function in the core unit 200 having no error. At this time, the processor unit 100 determines a change in alive core value set for each of the plurality of core units 200 to detect the error of the core unit 200. Therefore, when the alive count value of the software component 310 moving to the core unit 200 having no error is changed, the process unit 100 may determine whether the function is performed.

In addition, the core units 200 are divided into a high-performance core 210 assigned with the high-performance application 300 and a low-performance core 220 assigned with the low-performance application 300. In detail, like a case of sensing the motor control, occurrence of pulse width modulation (PWM), and a current on U, V, and W, the application 300 requiring the high performance is assigned to the high-performance core 210, and like a case where a processing time is longer like the temperature measurement, the application 300 requiring the low power is assigned to the low-performance core 220 by considering energy efficiency.

The resource unit 400 is formed with a GPIO, an interrupt, a timer, an analog-digital conversion module (ADC), a communication module (CAN), a memory, etc. At this time, the memory is formed so that the plurality of core units 200 transmits information to each other to replace an information transmitting method formed in an existing CAN communication method. In such a memory, a data transmission rate is high, storage is possible at a specific location, it is free from many problems which may occur in CAN communication in an environment where there is noise, hardware physical costs required for the implementation of the communication are not required, and a wire connected between the core unit 200 and the ECU is not required. In addition, a plurality of high-voltage wires is not required. In addition, the electronic unit 900 is used by adopting various communication schemes such as LIN and RS232, and in a multi-core scheme, since the information can be transmitted to an embedded memory, the information transmission is not required by other communication schemes.

Hereinafter, in an operating method of a multi-core system of an electric vehicle according to another embodiment of the present invention, the same configurations as the multi-core system of the electric vehicle according to the aforementioned embodiment use the same reference numerals, and the detailed description thereof will be omitted.

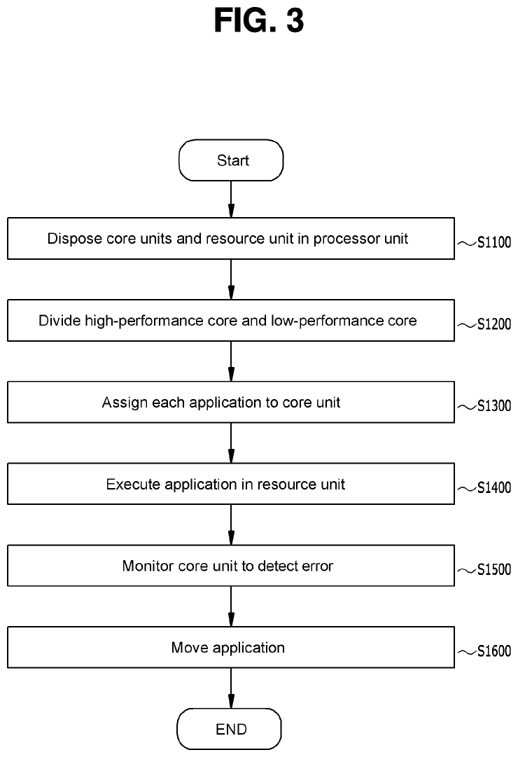

FIG. 3 is a flowchart illustrating an operating method of a multi-core system of an electric vehicle according to an embodiment of the present invention.

In step S1100, the core units 200 and the resource unit 400 may be disposed in the processor unit 100. The plurality of core units 200 is formed in the processor unit 100, and the plurality of core units 200 commonly uses the resources of the resource unit 400 to independently perform the operations.

In step S1200, the plurality of core units 200 may be divided into the high-performance core 210 and the low-performance core 220. In addition, in step S1300, the application 300 requiring high performance is assigned to the high-performance core 210, and in order to enhance the energy efficiency, the application 300 requiring the low power is assigned to the low-performance core 220 by considering the energy efficiency. At this time, the application 300 is configured by the plurality of software components 310.

In step S1400, the resource unit 400, which is formed with at least one of a GPIO, an interrupt, a timer, an analog-digital conversion module (ADC), a communication module (CAN), and a memory, may execute the application 300.

In step S1500, the plurality of core units 200 may be monitored to detect errors of the core units 200. At this time, the error of the core unit 200 may be monitored in the processor unit 100, a change in alive count value set in the plurality of core units 200 is received, and the received change in alive count value may be monitored to determine the error of the core unit 200.

In step S1600, the application 300 of the core unit 200 having the error in step S1500 moves to the other core unit 200 to be performed in the core unit 200 having no error.

As described above, the multi-core system of the electric vehicle according to the embodiment of the present invention and the operating method thereof have been described, but the spirit of the present invention is not limited to the embodiments disclosed in this specification. Further, those skilled in the art understanding the spirit of the present invention may easily propose other embodiments by addition, modification, deletion, and addition of components within a range of the same spirit, and these embodiments will be included in the scope of the present invention.

What is claimed is:

1. A multi-core system for performing a plurality of applications used in an electric vehicle, comprising;
a processor unit configured to perform the plurality of applications;
a plurality of core units which is formed in the processor unit and assigned with at least one of the plurality of applications; and
a resource unit which is commonly used in the plurality of core units and executes the plurality of applications,
wherein the resource unit is formed with at least one of a GPIO, an interrupt, a timer, an analog-digital conversion module (ADC), a communication module (CAN), and a memory, and
the memory is formed so that the plurality of core units transmits information to each other.

2. The multi-core system of claim 1, wherein the application is formed of a plurality of software components (SWCs), and the plurality of SWCs moves from the plurality of core units, respectively.

3. The multi-core system of claim 2, wherein the plurality of core units is formed, and when an error occurs, the application moves to the other core unit to perform functions of the application.

4. The multi-core system of claim 3, wherein the processor unit receives a change in alive count value set in the plurality of core units to determine the errors of the core units.

5. The multi-core system of claim 1, wherein the processor unit is embedded in integrated hardware together with a power distribution unit (PDU) distributing a high-voltage power supply line.

6. The multi-core system of claim 5, wherein the processor unit shares information via LIN and CAN communications with at least one electronic unit of a battery management system (BMS) and a on-board charger (OBC) which are formed outside the integrated hardware.

7. The multi-core system of claim 1, wherein the core units are divided into a high-performance core assigned with the high-performance application and a low-performance core assigned with the low-performance application.

8. The multi-core system of claim 7, wherein the low-performance core is assigned with the low-power application by considering energy efficiency.

9. An operating method of a multi-core system for performing a plurality of applications used in an electric vehicle, comprising;
(a) disposing a plurality of core units and a resource unit in a processor unit;
(b) dividing the plurality of core units into a high-performance core and a low-performance core;
(c) assigning the application to each of the plurality of core units;
(d) executing the application in the resource unit;
(e) detecting an error by monitoring the plurality of core units; and
(f) moving the application of the core unit having the error to the other core unit.

10. The operating method of claim 9, wherein in step (e), the processor unit receives a change in alive count value set in the plurality of core units and monitors the received change in alive count value to determine the errors of the core units.
